(19) United States
(12) Patent Application Publication
(10) Pub. No.: US 2006/0284057 A1
(43) Pub. Date: Dec. 21, 2006

(54) Color filter forming method and image sensor manufactured in the method

(76) Inventor: Cheol Soo Park, Gwangju City (KR)

Correspondence Address: CANTOR COLBURN, LLP, 55 GRIFFIN ROAD SOUTH, BLOOMFIELD, CT, 06002, US

(21) Appl. No.: 11/335,346

(22) Filed: Jan. 18, 2006

(30) Foreign Application Priority Data
Jun. 20, 2005 (KR) 10-2005-0052874

(51) Int. Cl. G01J 3/50

(52) U.S. Cl. 250/226

(57) ABSTRACT

Provided is a method of forming a color filter of an image sensor. The method is achieved by forming a trench region in a predetermined area after forming a top metal layer of a pixel of the image sensor, and forming the color filter in the trench region. A part of the color filter is formed to be convex through heat treatment to be used as a microlens. Since the color filter is formed in the trench region, optical cross talk is prevented and optical efficiency is improved.

### BACKGROUND OF THE INVENTION

1. Field of the Invention

The present invention relates to an image sensor, and more particularly, to a method of forming a color filter for an image sensor, and an image sensor manufactured in the method.

2. Description of the Related Art

FIG. 1 shows the construction of a conventional image sensor. Referring to FIG. 1, a P-well layer is formed by injecting ions into a silicon substrate. A field oxide film is formed using LOCOS(Local Oxidation of Silicon) or a trench isolation process that is a selective oxidation process. A gate electrode of a device is formed in a selective etching process. An N-ion injected region and a P-ion injected region are formed in the silicon substrate by a selective ion injection to form a photodiode. The remaining pixel area is formed by a typical semiconductor process.

Next, a light shield film is manufactured and unnecessary oxide films can be removed from a photosensitive area in a pixel array area. An SOG(Spin on Glass) oxide film is not exposed because the SOG oxide film is not used in a second IMD (Inter Metal Dielectric) layer. An oxide film is deposited as a device protective film. To form a pad open portion where a second metal wiring pattern is exposed in a peripheral area, the oxide film and other films located under the oxide film, which are a titanium nitride film that is the light shield film, the oxide film, a TEOS(Tetra Ethyl Ortho Silicate) oxide film, and a titanium nitride film that is a non-reflective layer, are selectively etched. A color filter is formed in the pixel area and a photoresist layer for leveling and a microlens are formed in a typical method.

In the conventional image sensor, optical cross talk frequently occurs between the neighboring pixels so that the quality of color is deteriorated.

### SUMMARY OF THE INVENTION

To solve the above and/or other problems, the present invention provides a method of forming a color filter for preventing optical cross talk between pixels in an image sensor and improving optical efficiency, and an image sensor manufactured in the method.

According to an aspect of the present invention, a method of forming a color filter of an image sensor is achieved by forming a trench region in a predetermined area after forming a top metal layer of a pixel of the image sensor, and forming the color filter in the trench region.

According to another aspect of the present invention, a method of forming a color filter of an image sensor is achieved by forming a trench region in a predetermined area after forming a top metal layer of a pixel of the image sensor, forming the color filter in the trench region, and forming part of the color filter to be convex through heat treatment.

According to another aspect of the present invention, a method of forming a color filter of an image sensor is achieved by forming a top metal layer of a pixel of the image sensor to be concave, and forming the color filter in a concave area of the top metal layer.

According to another aspect of the present invention, a method of forming a color filter of an image sensor is achieved by forming a trench region in a predetermined area after a top metal layer of a pixel of the image sensor is formed, forming the color filter in the trench region, insulating the color filter, and forming a protective layer on the color filter that is insulated.

According to another aspect of the present invention, an image sensor for preventing optical cross talk and improving optical efficiency comprises a top metal layer of a pixel of the image sensor, a trench region formed by etching a predetermined area of the top metal layer, a color filter formed in the trench region, and a protective layer formed on the color filer.

According to another aspect of the present invention, an image sensor for preventing optical cross talk and improving optical efficiency comprises a top metal layer of a pixel of the image sensor, part of which is formed concave, a color filter formed in a concave area of the top metal layer, and a protective layer formed on the color filer.

### BRIEF DESCRIPTION OF THE DRAWINGS

The above and other features and advantages of the present invention will become more apparent by describing in detail preferred embodiments thereof with reference to the attached drawings in which:

FIG. 1 is a view showing the construction of a conventional image sensor;

FIGS. 2A through 2D are views showing a method of forming a color filter for an image sensor according to an embodiment of the present invention;

FIG. 3 is a view showing the construction of an image sensor according to an embodiment of the present invention;

FIGS. 4A through 4D are views showing a method of forming a color filter for an image sensor according to an embodiment of the present invention; and

FIG. 5 is a view showing the total reflection according to the medium of a lateral wall of a trench region.

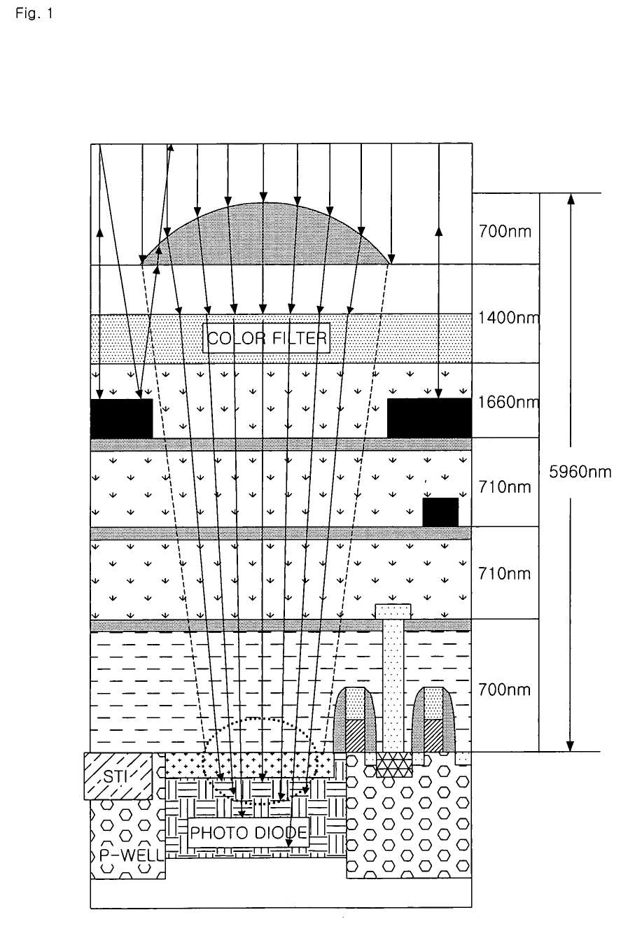

### DETAILED DESCRIPTION OF THE INVENTION

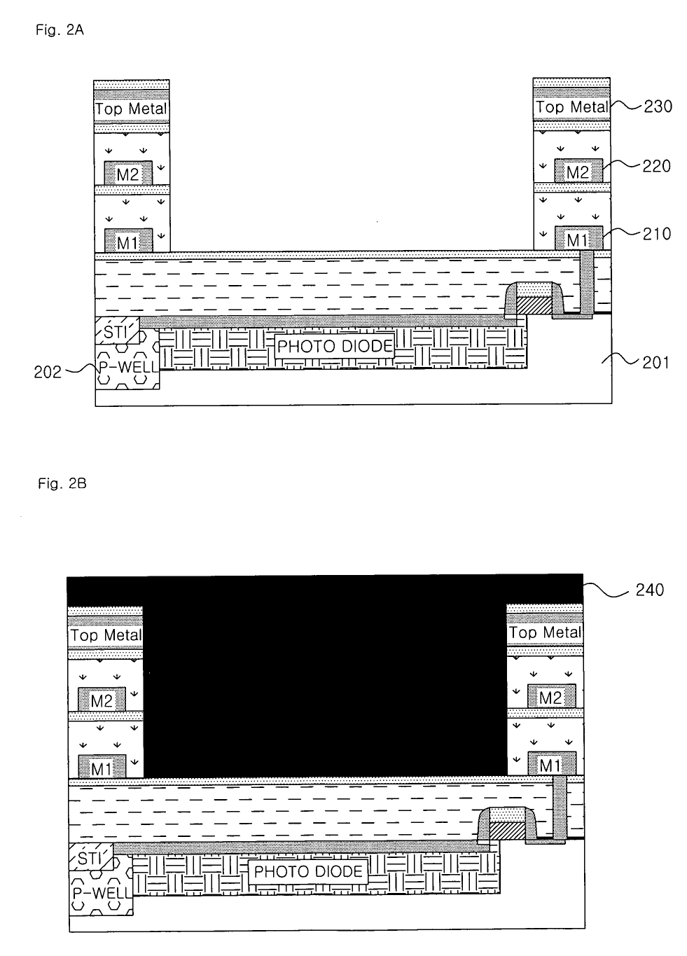

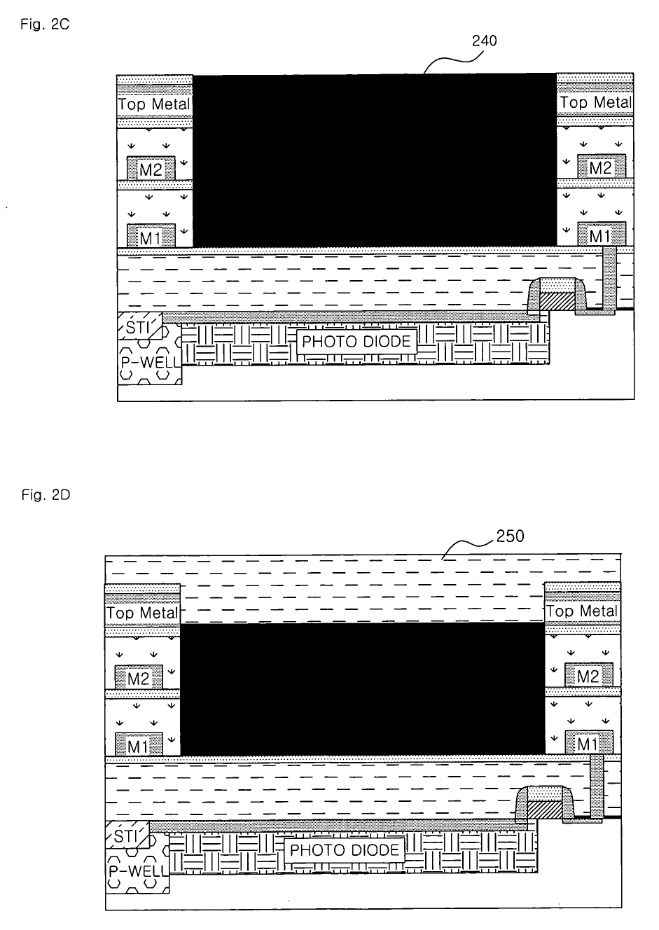

FIGS. 2A through 2D show a method of forming a color filter for an image sensor according to en embodiment of the present invention. Referring to FIGS. 2A through 2D, in a process of forming a photodiode on a substrate, a P-well layer 202 is formed by injecting ions into a silicon substrate 201. A field oxide film is formed using LOCOS or a trench isolation process that is a selective oxidation process.

A gate electrode of a device is formed in a selective etching process. The upper surface of the gate electrode is covered with a protective oxide film. An oxide film spacer is formed on both lateral walls of the gate electrode.

After the gate electrode is formed, an N-ion injected region and a P-ion injected region are formed in the silicon substrate 201 by a selective ion injection to form a photodiode. The remaining pixel area is formed by a typical semiconductor process.

Prior to the formation of a color filter, a top metal layer 230 is formed and a first metal layer 210 and a second metal layer 220 are formed under the top metal layer 230. As shown in FIG. 2A, a predetermined area at the center of the top metal layer 230 and the first and second metal layers 210 and 220 is etched. Next, as shown in FIG. 2B, a spacer nitride is formed in the etched area to form a trench area. A color filter 240 is formed in the trench area.

In FIG. 2C, the color filter 240 is insulated by either exposing the color filter 240 to light, grinding the upper portion of the color filter 240 through a chemical mechanical polishing (CMP) process, or etching the color filter 240 to a predetermined depth after the CMP process.

FIG. 2D shows a state in which a protective layer 250 is formed on the color filter 240 that is insulated. The protective layer 250 is formed of low thermal oxide (LTO) or polyimide.

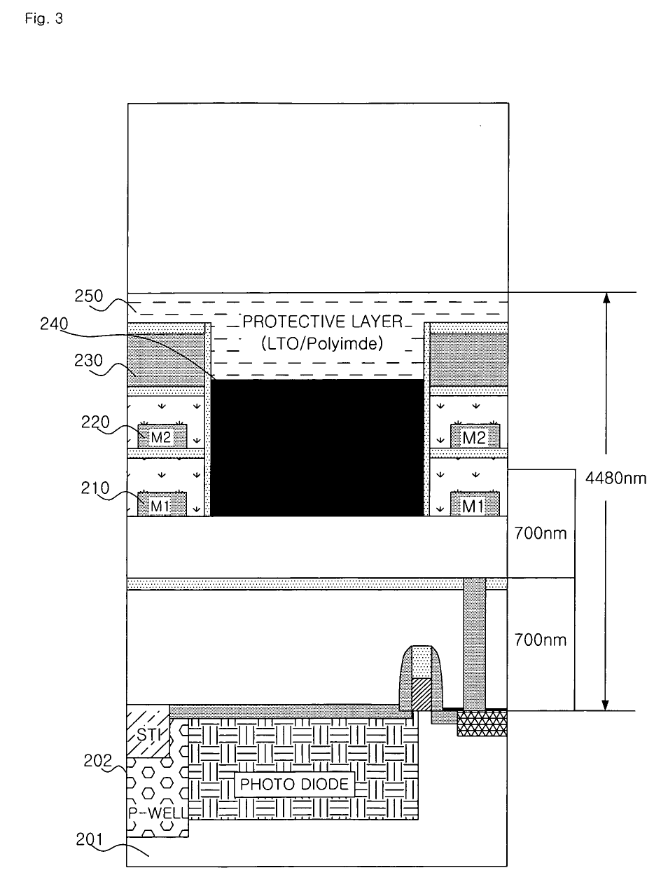

FIG. 3 illustrates the overall construction of an image sensor according to an embodiment of the present invention. In FIG. 3, the image sensor is manufactured through the processes shown in FIGS. 2A through 2D.

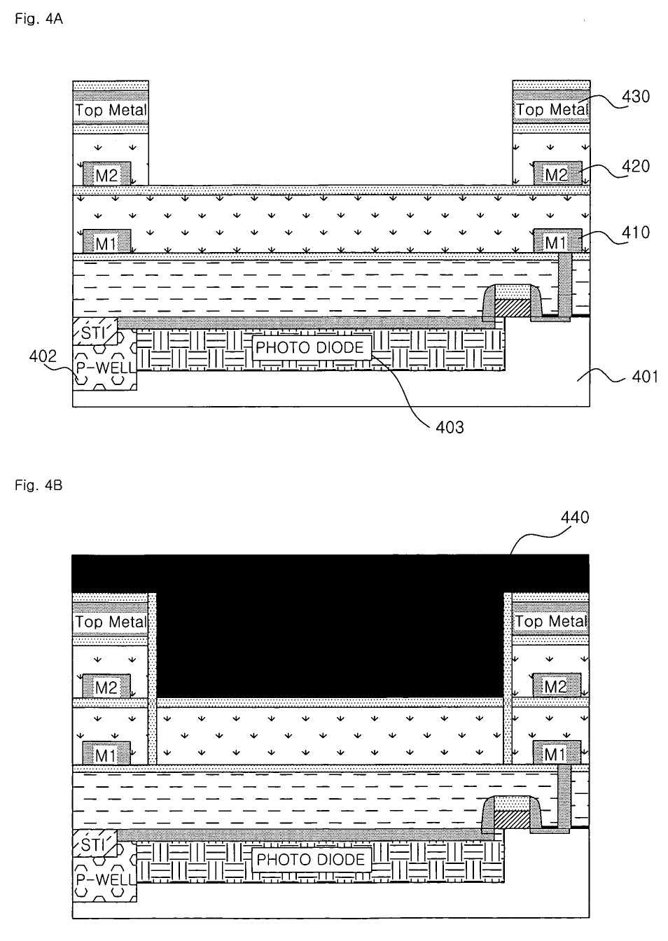

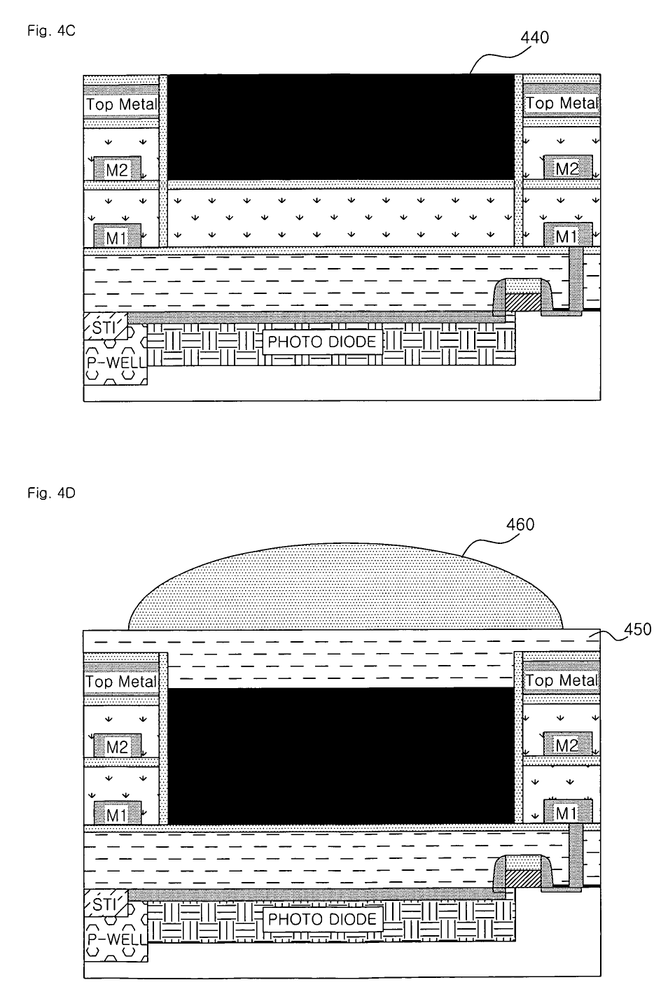

FIGS. 4A through 4D illustrate a method of forming a color filter for an image sensor according to an embodiment of the present invention. Referring to FIG. 4A through 4D, as shown in FIG. 2A, a photodiode 403 is formed in the substrate 401. Prior to the formation of a color filter, a top metal layer 430 and a first metal layer 410 and a second metal layer 420 located under the top metal layer 430 are formed.

A predetermined area at the center of the top metal layer 430 and the second metal layer 420 is etched as shown in FIG. 4A. As shown in FIG. 4B, a spacer nitride is formed in the etched area to form a trench area. Next, a color filter 440 is formed in the trench area.

FIG. 4C shows a state in which the color filter 440 is insulated. In FIG. 4C, the color filter 440 is insulated by either exposing the color filter 440 to light, grinding the upper portion of the color filter 440 through a chemical mechanical polishing (CMP) process, or etching the color filter 440 to a predetermined depth after the CMP process.

FIG. 4D shows a state in which the protective layer 450 and a microlens 460 are formed on the color filter 440 that is insulated. The protective layer 450 is formed of low thermal oxide (LTO) or polyimide.

As another method of forming a color filter of an image sensor according to the present invention, after the top metal layer of a pixel of the image sensor is formed, a trench area is formed in a predetermined area. A color filter is formed in the trench area and part of the color filter is made convex through heat treatment. In this method, the partially convex area can be used as a microlens.

Also, a color filter of an image sensor according to the present invention can be formed by forming the top metal layer of a pixel of the image sensor concave and forming a color filter in the concave area of the top metal layer. According to the present method, there is no need to form a trench area by etching the metal layer.

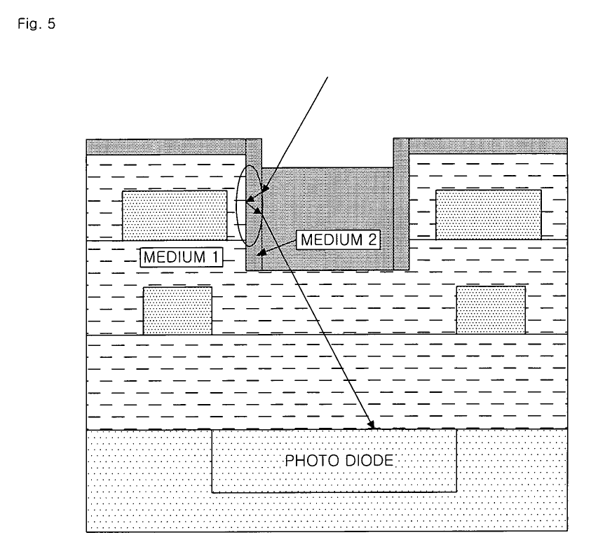

FIG. 5 is a view showing the total reflection according to the medium of a lateral wall of a trench region. After trench etching, a medium 2 having a refractive index greater than that of a medium 1 is formed on a lateral wall of the trench so that total reflection occurs when light comes from the medium 2 to the medium 1. Thus, optical cross talk between pixels is reduced, sensitivity is improved, and color reproduction is improved.

While this invention has been particularly shown and described with reference to preferred embodiments thereof, it will be understood by those skilled in the art that various changes in form and details may be made therein without departing from the spirit and scope of the invention as defined by the appended claims.

As described above, according to the present invention, since the color filter is formed in the trench region, optical cross talk can be prevented and optical efficiency can be improved.

1. A method of forming a color filter of an image sensor comprising:
forming a trench region in a predetermined area after forming a top metal layer of a pixel of the image sensor; and
forming the color filter in the trench region.

2. A method of forming a color filter of an image sensor comprising:
forming a trench region in a predetermined area after forming a top metal layer of a pixel of the image sensor;
forming the color filter in the trench region; and
forming part of the color filter to be convex through heat treatment.

3. The method as claimed in claim 1, wherein the trench region is formed by etching.

4. The method as claimed in claim 1, wherein the forming of the color filter comprises:
etching: and
forming a nitride layer after etching.

5. The method as claimed in claim 4, wherein the trench region has a lateral wall on which a second medium having a refractive index greater than that of a first medium is formed.

6. A method of forming a color filter of an image sensor comprising:
forming a top metal layer of a pixel of the image sensor to be concave; and
forming the color filter in a concave area of the top metal layer.

7. A method of forming a color filter of an image sensor comprising:
forming a trench region in a predetermined area after a top metal layer of a pixel of the image sensor is formed;
forming the color filter in the trench region;
insulating the color filter; and
forming a protective layer on the color filter that is insulated.

8. The method as claimed in claim 7, wherein in the insulating of the color filter the color filter is insulated by being exposed to light.

9. The method as claimed in claim 7, wherein in the insulating of the color filter the color filter is insulated by grinding an upper portion of the color filter through a chemical mechanical polishing (CMP) process.

10. The method as claimed in claim 7, wherein in the insulating of the color filter the color filter is insulated by etching the color filter to a predetermined thickness after a chemical mechanical polishing (CMP) process.

11. The method as claimed in claim 7, wherein the protective layer is formed of polyimide or low thermal oxide (LTO).

12. An image sensor for preventing optical cross talk and improving optical efficiency, the image sensor comprising:
a top metal layer of a pixel of the image sensor;
a trench region formed by etching a predetermined area of the top metal layer;
a color filter formed in the trench region; and
a protective layer formed on the color filer.

13. The image sensor as claimed in claim 12, wherein the trench region has a lateral wall on which a second medium having a refractive index greater than that of a first medium is formed.

14. The image sensor as claimed in claim 12, wherein a predetermined area at the center of the color filter is formed to be convex to be used as a microlens.

15. An image sensor for preventing optical cross talk and improving optical efficiency, the image sensor comprising:
a top metal layer of a pixel of the image sensor, part of which is formed concave;
a color filter formed in a concave area of the top metal layer; and
a protective layer formed on the color filer.

16. The method as claimed in claim 2, wherein the trench region is formed by etching.

17. The method as claimed in claim 2, wherein the forming of the color filter comprises:
etching: and
forming a nitride layer after etching.
